(19) United States
(12) Patent Application Publication
(10) Pub. No.: US 2006/0123103 A1
(43) Pub. Date: Jun. 8, 2006

(54) Communicating network management information using session initiation protocol architecture

(75) Inventors: Shiva J. Shankar, Bangalore (IN); Vishal K. Singh, New York, NY (US); Damodar Patakolusu, Bangalore (IN)

Correspondence Address: BAKER BOTTS L.L.P., 2001 ROSS AVENUE, SUITE 600, DALLAS, TX, 75201-2980, US

(73) Assignee: Cisco Technology, Inc.

(21) Appl. No.: 11/007,011

(22) Filed: Dec. 8, 2004

(51) Int. Cl. G06F 15/173

(52) U.S. Cl. 709/223

(57) ABSTRACT

Communicating network management information includes registering a network device using a device user agent corresponding to a first protocol. A request message for network management information is received from a network management server. The request message is corresponding to the first protocol, and comprises a request corresponding to a second protocol. The request corresponding to the second protocol is extracted, and the network management information is retrieved using the second protocol. The network management information is placed in a response message corresponding to the first protocol, and the response message is sent to the network management server.

### TECHNICAL FIELD

This invention relates generally to the field of communications and more specifically to communicating network management information using Session Initiation Protocol architecture.

### BACKGROUND

Network management techniques are used to provide services to manage the operation of communications networks. Network management techniques may be based on network management protocols such as Simple Network Management Protocol (SNMP). Certain network management techniques may involve other protocols such as Remote Method Invocation (RMI) interfaces, Common Object Request Broker Architecture (CORBA), Hypertext Transfer Protocol (HTTP), and Common Information Model/Extensible Markup Language (CIM/XML).

Known techniques, however, may not be effective in efficiently managing networks in certain situations. As an example, certain known techniques use talkative protocols. As another example, certain known techniques use interfaces that are not standardized. As yet another example, certain known techniques require the use of Internet Protocol (IP) addresses. It is typically beneficial to efficiently manage networks in certain situations.

### SUMMARY OF THE DISCLOSURE

In accordance with the present invention, disadvantages and problems associated with previous techniques for communicating network management information may be reduced or eliminated.

According to one embodiment of the present invention, communicating network management information includes registering a network device using a device user agent corresponding to a first protocol. A request message for network management information is received from a network management server. The request message is corresponding to the first protocol, and comprises a request corresponding to a second protocol. The request corresponding to the second protocol is extracted, and the network management information is retrieved using the second protocol. The network management information is placed in a response message corresponding to the first protocol, and the response message is sent to the network management server.

Certain embodiments of the invention may provide one or more technical advantages. A technical advantage of one embodiment may be that Session Initiation Protocol (SIP) may be used to communicate network management information. SIP may communicate more network management information in each message than can be carried in a Simple Network Management Protocol (SNMP) message, which may allow for more efficient network management. Another technical advantage of one embodiment may be that SIP may be used to communicate network management information retrieved using SNMP. Retrieving network management information using SNMP may provide for efficient implementation with devices that use SNMP.

Certain embodiments of the invention may include none, some, or all of the above technical advantages. One or more other technical advantages may be readily apparent to one skilled in the art from the figures, descriptions, and claims included herein.

### BRIEF DESCRIPTION OF THE DRAWINGS

For a more complete understanding of the present invention and its features and advantages, reference is now made to the following description, taken in conjunction with the accompanying drawings, in which:

FIG. 1 is a block diagram illustrating one embodiment of a system for communicating network management information using Session Initiation Protocol (SIP); and

FIG. 2 is a diagram illustrating one embodiment of a method for communicating network management information using SIP.

### DETAILED DESCRIPTION OF THE DRAWINGS

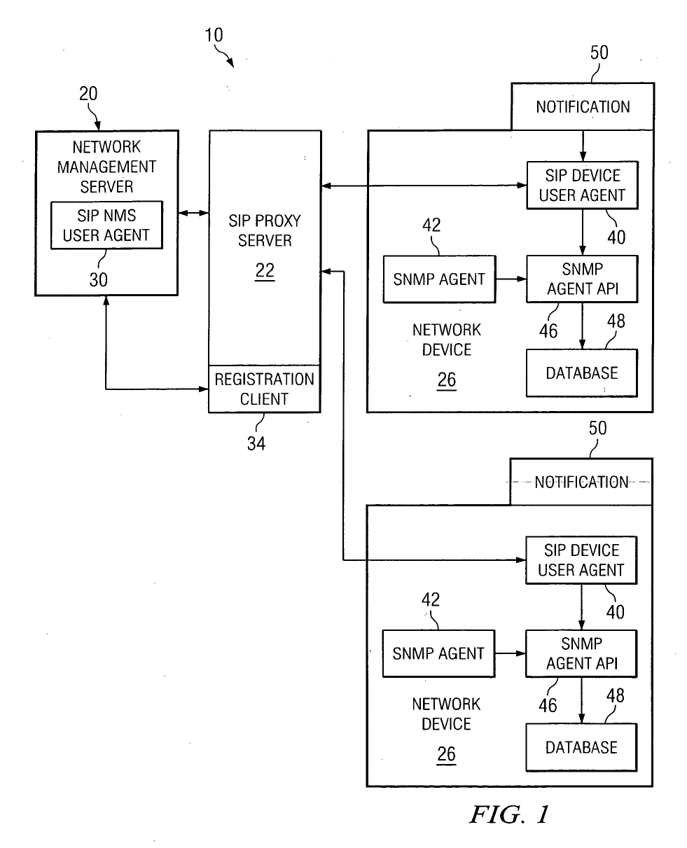

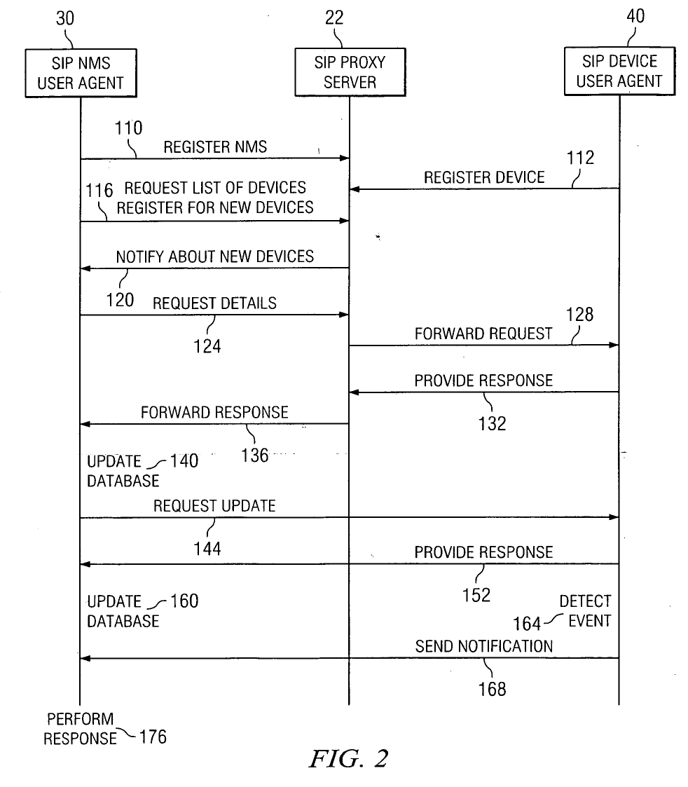

Embodiments of the present invention and its advantages are best understood by referring to FIGS. 1 and 2 of the drawings, like numerals being used for like and corresponding parts of the various drawings.

FIG. 1 is a block diagram illustrating one embodiment of a system 10 for communicating network management information using Session Initiation Protocol (SIP). System 10 uses SIP to communicate between a network management server (NMS) 20 and one or more network devices 26 while retaining the semantics and operations of a network management protocol.

Session Initiation Protocol refers to a standard for setting up real-time communications in an IP network, and is defined in Request for Comment (RFC) 2543 of the Internet Engineering Task Force (IETF). SIP provides for the establishment, modification, and termination of telephony sessions, and may operate at the application layer. SIP may run on top of a transport layer protocol such as UDP/TCP, and works independently of underlying transport layer protocol. SIP may be stateless, which may provide for scalability. According to one embodiment, SIP may be used to encapsulate a message of another protocol of the application layer, such as SNMP.

SIP provides primitives that may be used to implement different services. Services may include, for example, single time authentication, bulk data transfer, name mapping, redirection, or other suitable service. Services may also include security services such as denial-of-service prevention, authentication, integrity protection, encryption, or privacy services. SIP may be used for instant messaging using SIP for Instant Messaging and Presence Leveraging Extensions (SIMPLE). Transport Layer Security (TLS) may provide security for SIP.

According to one embodiment of the invention, a typical SIP message may carry more information per message than a typical SNMP message can carry. Accordingly, the use of SIP may provide for more efficient exchange of network management information. SIP may also provide an acknowledgement mechanism that guarantees that messages are either received at the appropriate element or retransmitted until received. As an example, if network management server 20 is going through a reboot, a message such as a trap may be dropped. SIP may allow for the message to be queued and delivered once network management server 20 has finished rebooting.

According to the illustrated embodiment, system 10 includes network management server (NMS) 20, a SIP proxy server 22, and one or more network devices 26 coupled as shown. According to the embodiment, network management server 20 and network device 26 may communicate messages through proxy server 22. A message may refer to a packet that is formatted according to a protocol, and that may be used to communicate information such as network management information. For example, a message may refer to a SIP message formatted according to SIP. The body of a SIP message may be used to transport the network management information. The network management information may be carried in a network management message, an error notification, or other manner. The network management message may be formatted according to any suitable network management protocol, such as Simple Network Management Protocol (SNMP), Common Object Request Broker Architecture (CORBA), or Command Line Interface (CLI).

According to one embodiment, SNMP may be used. Simple Network Management Protocol refers to a network management protocol developed by SNMP RESEARCH, INC. Network management applications may use SNMP to retrieve information from a network device, of any suitable network such as an Internet Protocol (IP) network. SNMP operates at the application layer, or layer 7 of the Open Systems Interconnection (OSI) reference model. SNMP may run on top of a transport layer protocol such as the User Datagram Protocol/Transmission Control Protocol (UDP/TCP). An SMNP message may comprise, for example, an SMNP request or SMNP response. An SMNP request may include an operation to be performed, the object identifier (OID) of the object for which the operation is to be performed, and a value associated with the operation, if needed. An SMNP response may include information retrieved in response to a request.

The operation of an SMNP request may comprise, for example, a command, such as a set, get, or get bulk command, and variables associated with the command. A set command is typically sent with an object identifier and a value for the object. The object identifier identifies the object to be set with the value. A get command or a get bulk command is typically sent with one or more requested object identifiers to request values. A response to a get command may include a mapping of object identifiers and the requested values. A response to a get bulk command may include an object identifier and a list of the requested values.

Network management server 20 provides network management services. Network management services may include fault management, configuration management, accounting management, performance management, security management, other type of network management, or any combination of the preceding. Fault management may address the identification, isolation, and correction of network faults. Fault management may support the testing and acceptance of a response, and the creation and management of fault history records. Configuration management may include installing, initializing, loading, modifying, and tracking configuration parameters of network logic. According to one embodiment, network management server 20 may provide for plug and play configuration of network devices 26 added to system 10. Configuration management may support the identification and tracking of physical and logical elements of a network.

Account management may include traffic and usage analysis, capital and operations costs, and cost allocation. Performance management may support the monitoring and improvement of the performance of networks. Performance management may be used to develop real-time or near real-time information about the performance of the network. Security management may manage access to network resources, maintain confidentiality, insure data integrity, and provide audit ability of usage.

Network management server 20 includes a SIP network management server (NMS) user agent 30. A user agent refers to any suitable client that implements a specific protocol to generate and receive messages. For example, a user agent may comprise any suitable SIP client that implements SIP to generate and receive SIP messages. According to the illustrated embodiment, user agent 30 generates SIP request messages that includes SNMP requests for information, and decodes SNMP responses included in SIP response messages. User agent 30 also registers network management server 20 with SIP proxy server 22 in order to communicate using SIP. Although user agent 30 is shown located at network management server 20, user agent 30 may be located at any element of the network.

SIP proxy server 22 relays messages between network management server 20 and network device 26, and may operate as a stateless proxy. A proxy server may refer to a logical entity that relays messages in a network. Proxy server 22 may handle any suitable number of messages at any suitable rate. For example, proxy server 22 may handle 500 or more messages per second. Proxy server 22 may operate to allocate resources to the elements of system 10.

Proxy server 22 includes a registration client 34, with which user agents of network elements may register their network elements. Registration client 34 accepts registration requests that include registration information. An element may be registered with a unique identifier such as an IP address that may have the format of “device@domain.” Registration client 34 places the registration information into a location service for the domain of registration client 34.

Proxy server 22 may store a record of registered elements such as a list of network devices 26 at a database. Proxy server 22 may alternatively store the record at a directory service such as a lightweight directory access protocol (LDAP) service. Proxy server 22 may update the presence of a network element in the event of a crash or a connection loss. Proxy server 22 may perform other operations. For example, proxy server 22 may also provide authentication operations for security purposes.

Network device 26 may refer to any suitable element of system 10 that may be monitored for network management purposes. For example, a network device 26 may comprise a gateway, a router, other network element, or any combination of the preceding.

Network device 26 includes a SIP device user agent 40, an SNMP agent 42, an SNMP agent application programming interface (API) 46, a database 48, and a notification engine 50 coupled as shown. User agent 40 registers with proxy server 22 in order to communicate with network management server 20 using SIP. User agent 40 may comprise, for example, a NIST instant messaging client.

User agent 40 may include a SIP message decoder and a SIP message processing unit. SIP message decoder retrieves SNMP messages from SIP messages and sends the SNMP messages to SNMP agent API 46 or database 48 to perform requested operations. An SNMP message decoder of SNMP agent API 46 processes the request and returns the results to the SIP message processing unit. The SIP message processing unit constructs a response based on the values returned by the SNMP message processing unit to generate a SIP message. Multiple operations may be performed substantially simultaneously in order to send a consolidated response back to network management server 20.

User agent 40 may be configured to set which values to pull, how often to pull the values, and how often to send the polled values to network management server 20. For example, user agent 40 may be configured to pull logical features every second and send the results every two minutes. According to one embodiment, an SNMP processing language may be used to designate SNMP variables to be queried, dependencies among the variables, and periodicity of polling database 48 and reporting to network management server 20. The language may also allow for basic scripting for cross-indexing across tables. For example, to retrieve port information for an interface, the language may be used to specify the identifier of the interface.

Although user agent 40 is shown as residing at network device 26, user agent 40 may be separate from network device 26. As an example, user agent 40 may reside at proxy server 22. A user agent 40 at proxy server 22 may aggregate network management information from multiple network devices 26.

SNMP agent API 46 operates to retrieve network management information from database 48. SNMP API 46 may obtain data from database 48 using Abstract Syntax Notation One (ASN.1) and basic encoding rules. SNMP agent 42 may communicate with network management server 20 using SNMP to allow network management server and network device 26 to communicate via SNMP in addition to SIP.

Database 40 stores network management information about network device 26. Network management information may refer to information about network management services and requests to obtain such information. Network management information may include, for example, information about the physical and logical features of network device 26. Physical features include, for example, the number of line cards of network device 26, the number of ports of network device 26, other physical features of network device 26, or any combination of the preceding. Physical information also includes the status of the physical features. Logical information includes, for example, the status of one or more layers of the OSI model of network device 26. Database 48 may comprise, for example, a management information base (MIB).

Notification engine 50 determines if there is a problem at device 26. If there is a problem, notification engine 50 notifies user agent 40. In response, user agent 40 sends a SIP notification message to proxy server 22. A SIP message may carry more information than an SNMP message, so the SIP message may include information about the problem such that network management server 20 may determine a response without requesting more information.

An element of system 10 may include any suitable configuration of an interface, logic, and memory for performing the operations of the element. An interface refers to any suitable structure of a device operable to receive input for the device, send output from the device, or both, and may comprise one or more ports. Logic refers to any suitable hardware, software, or combination of hardware and software. For example, logic may comprise a processor. A processor may refer to any suitable device operable to execute instructions and manipulate data to perform operations. Memory refers to any structure operable to store and facilitate retrieval of information used by a processor, and may comprise Random Access Memory (RAM), Read Only Memory (ROM), magnetic drives, disk drives, Compact Disk (CD) Drives, Digital Video Disk (DVD) drives, removable media storage, any other suitable data storage device, or a combination of any of the preceding.

Modifications, additions, or omissions may be made to system 10 without departing from the scope of the invention. For example, SNMP agent 42 and SNMP agent API 46 may be omitted. The components of system 10 may be integrated or separated according to particular needs. For example, user agent 40 of network device 26 may be located separate from network device 26 and may operate as a proxy for network device 26.

Moreover, the operations of system 10 may be performed by more, fewer, or other modules. For example, the operations of SNMP agent 42 and SNMP agent API may be performed by one module. Additionally, operations of system 10 may be performed using any suitable logic comprising software, hardware, other logic, or any suitable combination of the preceding. As used in this document, “each” refers to each member of a set or each member of a subset of a set.

FIG. 2 is a diagram illustrating one embodiment of a method for communicating network management information using SIP. The method begins at step 110, where SIP NMS user agent 30 registers network management server 20 with SIP proxy server 22. NMS user agent 30 may register using a unique identifier such as an IP address. SIP device user agent 40 registers network device 26 with SIP proxy server 22 at step 112. Device user agent 40 may also register with a unique identifier.

Steps 116-120 allow for autodiscovery. NMS user agent 30 requests a list of registered devices from proxy server 22 and registers for callbacks for new devices from proxy server 22 at step 116. Requesting the list of registered devices allows network management server 20 to perform efficient autodiscovery of network devices 26. Registering for notification of new devices allows network management server 20 to be automatically updated. Proxy server 22 notifies NMS user agent 30 when new devices are registered at step 120.

Steps 124-140 allow for inventory collection and for direct communication between NMS user agent 30 and device user agent 40. NMS user agent 30 initiates discovery of a new device, and send a request message to request information about the new device at step 124. Network management server 20 constructs a SIP request message to retrieve network management information from network device 26. The message includes an SNMP request comprising variables describing the requested information.

Proxy server 22 forwards the request message at step 128. Device user agent 40 decodes the request message and runs queries for the requested information on database 48 using SNMP agent API 46. The results may include values for the variables. Device user agent 40 places the results of the query into an SNMP response of a SIP response message. The response may include the values and a description of errors encountered while performing the query. Device user agent 40 provides the response message at step 132, and proxy server 22 forwards the response message at step 136. NMS user agent 30 receives the response message, decodes the response of the response message, and retrieves the values from the response. Network management server 40 updates its database with the returned values at step 140. NMS user agent 30 and device user agent 40 directly communicate at this point.

Steps 144-160 describe a periodic update that network management server 20 may perform on network device 26. NMS user agent 30 sends a SIP update request message for an update of network device 26 at step 144. Device user agent 40 receives the update request message, and retrieves the requested update from database 48 using SNMP agent API 46. Device user agent 40 places the requested update in an SNMP update response of a SIP update response message. User agent 40 provides the update response message at step 152. Network management server 20 updates the network management database at step 160.

Steps 164-176 describe communicating a fault notification from network device 26 to network management server 20. Notification module 50 detects an event that requires providing a notification to network management server 20 at step 164. The event may comprise, for example, a fault. Device user agent 40 places information describing the event in a SIP notification message. The information may comprise, for example, a trap, a SYS log message, other fault information, or any combination of the preceding. User agent 40 sends the notification message at step 168. User agent 30 receives the notification message and performs the appropriate response at step 176.

Modifications, additions, or omissions may be made to the method without departing from the scope of the invention. The method may include more, fewer, or other steps. Additionally, steps may be performed in any suitable order without departing from the scope of the invention.

Certain embodiments of the invention may provide one or more technical advantages. A technical advantage of one embodiment may be that Session Initiation Protocol (SIP) may be used to communicate network management information. SIP may communicate more network management information in each message than can be carried in a Simple Network Management Protocol (SNMP) message, which may allow for more efficient network management. Another technical advantage of one embodiment may be that SIP may be used to communicate network management information retrieved using SNMP. Retrieving network management information using SNMP may provide for efficient implementation with devices that use SNMP.

While this disclosure has been described in terms of certain embodiments and generally associated methods, alterations and permutations of the embodiments and methods will be apparent to those skilled in the art. Accordingly, the above description of example embodiments does not constrain this disclosure. Other changes, substitutions, and alterations are also possible without departing from the spirit and scope of this disclosure, as defined by the following claims.

What is claimed is:

1. A method for communicating network management information, comprising:
registering a network device using a device user agent corresponding to a first protocol, the first protocol comprising an application layer protocol;
receiving a request message for network management information describing the network device from a network management server, the request message corresponding to the first protocol, the request message comprising a request corresponding to a second protocol, the second protocol comprising an application layer protocol;
extracting the request corresponding to the second protocol;
retrieving the network management information using the second protocol;
placing the network management information in a response message corresponding to the first protocol; and
sending the response message to the network management server.

2. The method of claim 1, wherein:
the first protocol comprises a Session Initiation Protocol; and
the second protocol comprises a Simple Network Management Protocol.

3. The method of claim 1, further comprising:
registering the network device at a proxy server associated with the first protocol; and
communicating with the network management server through the proxy server using the first protocol.

4. The method of claim 1, further comprising:
receiving an update request message corresponding to the first protocol, the update request message comprising an update request for updated network management information, the update request corresponding to the second protocol; and
providing the updated network management information in an update response message corresponding to the first protocol, the update response message comprising an update response the request, the update response corresponding to the second protocol.

5. The method of claim 1, further comprising:
detecting a fault at the network device;
collecting fault information;
placing the fault information in a message corresponding to the first protocol; and
sending the notification message to the network management server.

6. The method of claim 1, wherein the device user agent resides at the network device.

7. The method of claim 1, wherein the device user agent resides at a device proxy coupled to the network device.

8. A device user agent for communicating network management information, comprising:
an interface operable to send a message corresponding to a first protocol, the first protocol comprising an application layer protocol; and
a processor coupled to the interface and operable to:
register a network device;
receive a request message for network management information describing the network device from a network management server, the request message corresponding to the first protocol, the request message comprising a request corresponding to a second protocol, the second protocol comprising an application layer protocol;
extract the request corresponding to the second protocol;
retrieve the network management information using the second protocol;
place the network management information in a response message corresponding to the first protocol; and
send the response message to the network management server.

9. The device user agent of claim 8, wherein:
the first protocol comprises a Session Initiation Protocol; and
the second protocol comprises a Simple Network Management Protocol.

10. The device user agent of claim 8, the processor further operable to:
register the network device at a proxy server associated with the first protocol; and
communicate with the network management server through the proxy server using the first protocol.

11. The device user agent of claim 8, the processor further operable to:
receive an update request message corresponding to the first protocol, the update request message comprising an update request for updated network management information, the update request corresponding to the second protocol; and
provide the updated network management information in an update response message corresponding to the first protocol, the update response message comprising an update response the request, the update response corresponding to the second protocol.

12. The device user agent of claim 8, further comprising a notification engine operable to:
detect a fault at the network device; and
collect fault information;
the processor further operable to:
place the fault information in a message corresponding to the first protocol; and
send the notification message to the network management server.

13. The device user agent of claim 8, wherein the device user agent resides at the network device.

14. The device user agent of claim 8, wherein the device user agent resides at a device proxy coupled to the network device.

15. Logic for communicating network management information, the logic embodied in a medium and operable to:
register a network device using a device user agent corresponding to a first protocol, the first protocol comprising an application layer protocol;
receive a request message for network management information describing the network device from a network management server, the request message corresponding to the first protocol, the request message comprising a request corresponding to a second protocol, the second protocol comprising an application layer protocol;
extract the request corresponding to the second protocol;
retrieve the network management information using the second protocol;
place the network management information in a response message corresponding to the first protocol; and
send the response message to the network management server.

16. The logic of claim 15, wherein:
the first protocol comprises a Session Initiation Protocol; and
the second protocol comprises a Simple Network Management Protocol.

17. The logic of claim 15, further operable to:
register the network device at a proxy server associated with the first protocol; and
communicate with the network management server through the proxy server using the first protocol.

18. The logic of claim 15, further operable to:
receive an update request message corresponding to the first protocol, the update request message comprising an update request for updated network management information, the update request corresponding to the second protocol; and
provide the updated network management information in an update response message corresponding to the first protocol, the update response message comprising an update response the request, the update response corresponding to the second protocol.

19. The logic of claim 15, further operable to:
detect a fault at the network device;
collect fault information;
place the fault information in a message corresponding to the first protocol; and
send the notification message to the network management server.

20. The logic of claim 15, wherein the device user agent resides at the network device.

21. The logic of claim 15, wherein the device user agent resides at a device proxy coupled to the network device.

22. A system for communicating network management information, comprising:
means for registering a network device using a device user agent corresponding to a first protocol, the first protocol comprising an application layer protocol;
means for receiving a request message for network management information describing the network device from a network management server, the request message corresponding to the first protocol, the request message comprising a request corresponding to a second protocol, the second protocol comprising an application layer protocol;
means for extracting the request corresponding to the second protocol;
means for retrieving the network management information using the second protocol;
means for placing the network management information in a response message corresponding to the first protocol; and
means for sending the response message to the network management server.

23. A method for communicating network management information, comprising:
registering a network device at a proxy server using a device user agent corresponding to a first protocol, the first protocol comprising an application layer protocol, the first protocol comprising a Session Initiation Protocol, the device user agent residing at a device proxy coupled to the network device;
receiving a request message for network management information describing the network device from a network management server, the request message communicated through the proxy server using the first protocol, the request message corresponding to the first protocol, the request message comprising a request corresponding to a second protocol, the second protocol comprising an application layer protocol, the second protocol comprising a Simple Network Management Protocol;
extracting the request corresponding to the second protocol;
retrieving the network management information using the second protocol;
placing the network management information in a response message corresponding to the first protocol;
sending the response message to the network management server;
receiving an update request message corresponding to the first protocol, the update request message comprising an update request for updated network management information, the update request corresponding to the second protocol;
providing the updated network management information in an update response message corresponding to the first protocol, the update response message comprising an update response the request, the update response corresponding to the second protocol;
detecting a fault at the network device;
collecting fault information;
placing the fault information in a message corresponding to the first protocol; and
sending the notification message to the network management server.

24. A system for communicating network management information, comprising:
a network management server user agent operable to:
communicate a plurality of messages from a network management server according to a first protocol; and
register with a proxy server associated with the first protocol; and
a device user agent operable to:
communicate a plurality of messages from a network device according to the first protocol; and
register the device with the proxy server;
the network management user agent further operable to send a request message for network management information to the device user agent according to the first protocol, the request message comprising a request corresponding to a second protocol; and
the device user agent further operable to:
extract a request corresponding to a second protocol;
retrieve the network management information using the second protocol; and
place the network management information in a response message corresponding to the first protocol.

25. The system of claim 24, wherein:
the first protocol comprises a Session Initiation Protocol; and
the second protocol comprises a Simple Network Management Protocol.

26. The system of claim 24, the device user agent further operable to:
register the network device at a proxy server associated with the first protocol; and
communicate with the network management server through the proxy server using the first protocol.

27. The system of claim 24, the device user agent further operable to:
receive an update request message corresponding to the first protocol, the update request message comprising an update request for updated network management information, the update request corresponding to the second protocol; and
provide the updated network management information in an update response message corresponding to the first protocol, the update response message comprising an update response the request, the update response corresponding to the second protocol.

28. The system of claim 24, the device user agent further operable to:
detect a fault at the network device;
collect fault information;
place the fault information in a message corresponding to the first protocol; and
send the notification message to the network management server.

29. The system of claim 24, wherein the device user agent resides at the network device.

30. The system of claim 24, wherein the device user agent resides at a device proxy coupled to the network device.
